(19) United States
(12) Patent Application Publication
(10) Pub. No.: US 2019/0147403 A1
(43) Pub. Date: May 16, 2019

(54) SYSTEMS AND METHODS FOR A MESSAGE COMPLIANCE SERVICE

(71) Applicant: MH SUB I, LLC, El Segundo, CA (US)

(72) Inventors: Douglas William Lawrence, Berkeley, CA (US); Jeffrey Alan Sullivan, Rancho Palos Verdes, CA (US)

(21) Appl. No.: 15/811,502

(22) Filed: Nov. 13, 2017

(51) Int. Cl. G06Q 10/10; H04L 12/58; H04L 9/32; G06Q 10/06

(52) U.S. Cl. CPC G06Q 10/107; G06Q 10/0633; H04L 9/3215; H04L 51/30

(57) ABSTRACT

A system for determining compliance of one or more regulations and/or business rules according to transmission of a proposed communication to an intended recipient at a specified time of delivery is disclosed. The system comprises a server device includes executable instructions configured to perform operations including receiving, from a business, a request for a determination as to whether transmission of the proposed communication to the intended recipient at a specified time of delivery would violate one or more regulations and/or business rules. In response to receiving the request, the system retrieves business metadata and proposed communication metadata, parses the proposed communication metadata to determine a communication type and selects a workflow from a set of workflows based thereon. The system then analyzes the metadata according to the selected workflow to determine whether transmission of the proposed communication to the intended recipient at the specified time of delivery would violate the one or more regulations and/or business rules.

### FIELD

Embodiments of the disclosure relate to the field of automated communication compliance. More specifically, one embodiment of the disclosure relates to a system for automatically determining whether a communication may be transmitted to a particular recipient at a particular time according to a rules-based analysis utilizing a plurality of enacted laws and regulations.

### GENERAL BACKGROUND

Today, the transmission and exchange of information occurs at a greater rate than it ever has before due to the ubiquity of electronic devices capable of connecting to the internet, social media, automated messaging systems, etc. Specifically, businesses have begun utilizing electronic communications to transmit information to consumers. Although the ease in which businesses distribute electronic communications has led to an influx of information in the marketplace enabling consumers to easily compare goods and rebates among various stores, be notified of new products, etc., this has also led to consumers receiving large quantities of spam. Spam is generally defined as unsolicited messages, often advertising messages, typically transmitted via an electronic medium such as email, text messages, and/or telephone calls (e.g., automated calls). Herein, the term “communication type” may include an electronic medium.

The amount of spam consumers have been receiving the past few years has led to a public outcry for the enactment of laws and regulations to police the amount of communications one business may transmit to an individual. These laws and regulations (“legislation”) also seek to regulate particular aspects of the communications such as the content of the communications, header information (e.g., sender and recipient routing information, accurate domain names, etc.), opt-out mechanisms, etc. Various governmental agencies have enacted legislation with differing requirements and covering differing geographic regions with respect to the recipients. Examples of enacted legislation include, but are not limited or restricted to, the CAN-SPAM Act enacted by the United States government, Canada's Anti-Spam Law (CASL), the United Kingdom's Data Protection Act, France's Article L 43-5 Code of Postal and Electronic Communications, the European Union's Directive on Privacy and Electronic Communications, etc. Other regulations also control the permissible timing, content and consent requirements for messages in a variety of industries, such as the United States' Health Insurance Portability and Accountability Act (HIPAA) and the Children's Online Privacy Protection Act (COPPA). Additionally, several other states and countries have enacted their own legislation directed at policing the transmission of electronic communications to recipients within that state or country aiming to combat spam. Although this legislation is directed at combatting the proliferation of spam, businesses need to ensure their transmission of communications do not violate any enacted legislation.

However, some businesses, such as medical offices, dentist offices, car dealerships, online subscription services to name a few, often form relationships with their clients such that regular, routine transmission of legitimate messages is warranted (e.g., these may be examples of an “established business relationship”). As enacted legislation varies across each state, country and industry of a business, determining whether transmission of a communication to each recipient is permissible has become a cumbersome and difficult job. Specifically, a communication being sent to hundreds or thousands of recipients in varying geographic regions may need to be evaluated against several legislations with differing requirements. Additionally, as some legislation may regulate the number of messages being sent to a particular recipient in a specified timeframe, the history of communications transmitted to a recipient may need to be considered in evaluating whether the transmission of the communication to a particular recipient will violate enacted legislation.

Further, there is no current method or system that enables a business to present a record of the analysis performed for determination as to whether a proposed communication may be transmitted to an intended recipient in order to verify such transmission was compliant with all legislation, and optionally all business rules, enacted or established at the time of transmission.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 provides an exemplary block diagram of a Communication Compliance Service (CCS) system on a first server and a legacy compliance system on a second server, both connected to a network;

FIGS. 2A-2B provide an exemplary flow diagram of an analysis performed by the CCS system 100 of FIG. 1 to determine the compliance of transmitting a communication according to legislation and rules specific to a business;

FIGS. 3A-3C provide an exemplary flowchart illustrating a workflow for determining the permissibility of transmitting a text message to an intended recipient based on regulation guidelines;

FIGS. 4A-4C a second exemplary flowchart illustrating a workflow for determining the permissibility of transmitting a text message to an intended recipient based on regulation guidelines;

FIG. 5 provides an exemplary flowchart illustrating a workflow for determining the permissibility of transmitting an email to an intended recipient based on regulation guidelines; and

FIG. 6 provides an exemplary embodiment of a logical representation of the Communication Compliance Service (CCS) system of FIG. 1.

### DETAILED DESCRIPTION

Various embodiments of the disclosure are directed to a Communication Compliance Service (CCS) system that is designed to analyze metadata of a communication to be sent to one or more recipients and determine whether transmission of the communication to an intended recipient at a specified time of delivery would violate one or more laws or regulations (“legislation”) governing the transmission of electronic communications. Specifically, in some embodiments, the CCS system may receive a request for such a determination by a business with the request including the metadata of the potential communication to be sent. In some embodiments, the metadata of the communication includes an identifier of the business, an identifier of the intended recipient, a time of delivery and/or a type of communication (e.g., the channel over, or medium through, which the communication will be transmitted).

In some embodiments, the CCS system may perform one or more analyses as a result of receiving a request and the metadata corresponding to the proposed communication. The one or more analyses may include a rules based analysis based on information provided within the request and the communication metadata. As a general overview, the one or more analyses may, inter alia, seek to determine whether transmission of the proposed communication violates any enacted legislation and/or rules established by the business seeking to transmit the proposed communication. The one or more analyses may include a comparison of the request and the communication metadata with the communication history between the intended recipient and the business to determine whether transmission of the proposed communication would, inter alia, exceed a defined threshold of communications transmitted to the intended recipient within a predetermined time period or be delivered outside of a predefined time range. As one example, the one or more analyses may perform a correlation between (i) the request and the communication metadata, and (ii) one or more predefined rule sets to determine whether the proposed communication, e.g., an email, (to an intended recipient at a specified time of delivery) exceeds a predefined number of emails transmitted by the business to the intended recipient within a predefined time range that includes the specified time of delivery.

More specifically, upon receiving such a request, the CCS system may parse the communication metadata to determine the type of the communication (e.g., email, text message, phone call, etc.). According to the type of communication, the CCS system selects a workflow comprising a particular logic flow (e.g., logical steps, operations, processes, determinations or analyses that may include one or more predetermined rule sets) that is to be utilized by a compliance logic module in automatically determining whether transmission of the proposed communication to the intended recipient at a specified time of delivery is permitted according to applicable, enacted legislation and/or specific rules of the business seeking to transmit the proposed communication.

In some embodiments, the CCS system includes a rules engine (e.g., compliance logic) that interprets the request, parses the communication metadata, selects a workflow according to the communication metadata, performs an evaluation of at least the communication metadata according to the selected workflow and the history of communications transmitted to the intended recipient, and provides the requesting business a result (e.g., a notification that the proposed communication may be sent or a denial of the request to send the proposed communication). When the result of the determination is that the communication may be sent without violating any enacted legislation and, optionally, any specific rules of the business, the CCS system stores the communication metadata and the selected workflow (along with a recording of a path taken during evaluation using the selected workflow). The communication metadata and the selected workflow may be used to automatically verify that the transmission of the communication did not violate any enacted legislation if an inquiry from the recipient or a third-party with standing arises. When the result of the determination is a denial (e.g., transmission of the communication to the intended recipient at the specified time of delivery would violate enacted legislation and/or a specific rule of the business), the requesting business is provided with a reasoning for the denial (e.g., at least a portion of the path taken in the selected workflow by the compliance logic presenting the reason for non-compliance). As one example of reasoning for the denial, the denial may specify that the maximum number of communications transmitted to the intended recipient within a certain timeframe that includes the time of delivery without violating enacted legislation has already been transmitted. In one embodiment, a request may be received by the CCS system (e.g., the management logic and optionally provided to the compliance logic) that inquires as to verification of a particular transmission (e.g., to a specific recipient at a specified time of delivery). The management logic or the compliance logic may parse the request to determine the recipient and specified communication. Based on the determination of the recipient and specified communication, the management logic or the compliance logic retrieves the stored communication metadata and the selected workflow (along with a recording of a path taken within the workflow), which may be provided to the business (e.g., as attachments in a communication and/or via a graphic user interface) as verification that the transmitted communication complied with all legislation and optionally all business rules enacted or established at the time of delivery.

### I. Terminology

In the following description, certain terminology is used to describe features of the invention. For example, in certain situations, the term “logic” and “component” are representative of hardware, firmware or software that is configured to perform one or more functions. As hardware, a component (or logic) may include circuitry having data processing or storage functionality. Examples of such circuitry may include, but are not limited or restricted to a hardware processor (e.g., microprocessor with one or more processor cores, a digital signal processor, a programmable gate array, a microcontroller, an application specific integrated circuit “ASIC,” etc.), a semiconductor memory, or combinatorial elements.

Alternatively, the component (or logic) may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” should be construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: a server, an endpoint device (e.g., a laptop, a smartphone, a tablet, a desktop computer, a netbook, a medical device, or any general-purpose or special-purpose, user-controlled electronic device); a mainframe; a router; or the like.

A “communication” generally refers to information transmitted in one or more electrical signals that collectively represent electrically stored data in a prescribed format. Each communication may be in the form of one or more packets, frames, HTTP-based transmissions, signals transmitted over telephone lines, or any other series of bits having the prescribed format. Herein, the terms “message,” “communication” and “communication message” are used interchangeably. Specifically, the term “text message” refers to a communication transmitted to a phone number and transmitted via either a cellular data service provider (e.g., AT&T, Verizon, Sprint, etc.) or a set of private servers (e.g., privately owned or through cloud computing). Examples of text messages include, but are not limited or restricted to, short message service (SMS) messages and/or Apple iMessages®.

The term “computerized” generally represents that any corresponding operations are conducted by hardware in combination with software and/or firmware.

The term “business” generally refers to an individual, group, unincorporated association, limited or general partnership, corporation, or other business entity.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### II. General Architecture

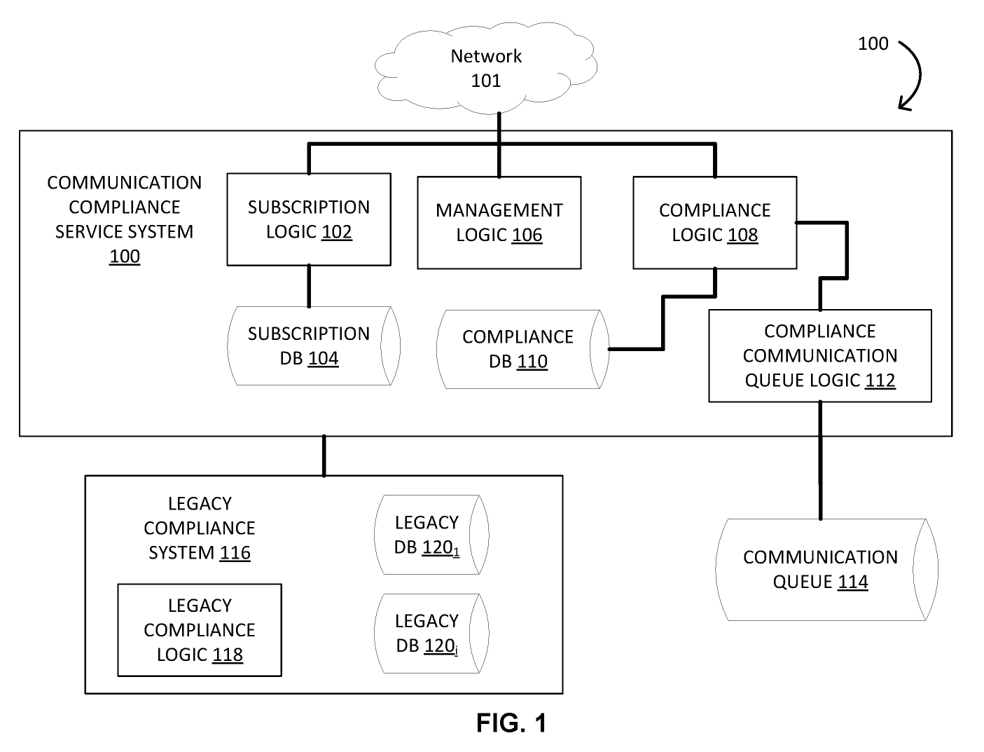

Referring now to FIG. 1, an exemplary block diagram of a Communication Compliance Service (CCS) system on a first server and a legacy compliance system on a second server, both connected to a network is shown. The illustration of FIG. 1 includes the CCS system 100 communicatively coupled to the legacy compliance system 116. In one embodiment, the CCS system 100 may be communicatively coupled to the legacy compliance system 116 via the network 101. In a second embodiment, the communicative coupling may be via a direct connection (e.g., hardwire connection). The CCS system 100 is seen to comprise a subscription logic 102, a subscription database 104, a management logic 106, a compliance logic 108, a compliance database 110 and a compliance communication queue (CQ) logic 112, which is communicatively coupled to a CQ 114.

The subscription logic 102 is configured to track the opt-status (e.g., opt-in, opt-out, or opt-neutral) of each recipient who is to receive communications from a business that utilizes the CCS system 100 (recipients may be, e.g., consumers, club members, those who signed up to receive newsletters or other subscriptions, or the like). The opt-status of a recipient may be provided directly to the subscription logic 102 via an application programming interface (API) via the network 101. For example, the subscription logic 102 may receive data via the API from a business when the business receives a request from a recipient of a communication to unsubscribe from a particular type of communication from the business. Alternatively, the subscription logic 102 may receive data via an API from a business that provides an affirmative statement of a consumer opting into receiving all or one or more particular types of communications, which will be discussed below. Examples of affirmative opt-out of or opt-in communications may include communications that affirmatively opt-out of or opt-in to all communications from a particular business, affirmatively opt-out of or opt-in to communications transmitted over one or more specific channels (or mediums) from a particular business, affirmatively opt-out of or opt-in to specific categories of communications and/or subcategories. For example, a consumer may opt-in or opt-out of: communications of a particular type (e.g., reminder communications), communications of a subcategory of a particular type (e.g., type: reminder communications, subcategory: day-of reminders), and/or communications transmitted over a particular channel (e.g., email, text messages, phone calls, etc.). The subscription logic 102 maintains records of each consumer's opt-status in the subscription database 104 by, for example, storing an opt-status along with a consumer identifier and a business identifier (e.g., a consumer may have different opt-statuses with different businesses).

Communications may be transmitted over one or more channels such as via email, text messaging, phone calls, voice over internet protocol (VoIP), video calls, chat messaging, etc. A particular business may define various categories within each type of communication (e.g., reminders, confirmations, recalls, advertisements, office closure notifications, holiday wishes, etc.). Additionally, each category may be broken down into subcategories. As one non-limiting example, a category within a communication type of a business defined as “reminders” may be comprised of several subcategories including, but not limited or restricted to: “advanced, 1 week reminder”; “two-day reminder with confirmation request”; and “day-of reminder.” In such an example, a consumer of the particular business may affirmatively opt-out of or opt-in to (i) the entire category of “reminders” or (ii) one or more particular subcategories of the entire category of “reminders.” Further, the consumer may affirmatively opt-out of or opt-in to any communication type, category and/or subcategory for the particular business.

As will be discussed below, the compliance logic 108 may query the subscription logic 102 to determine whether an intended recipient has provided a statement to the particular business affirmatively opting-in or opting-out of the particular type of proposed communication during the analysis by the compliance logic 108.

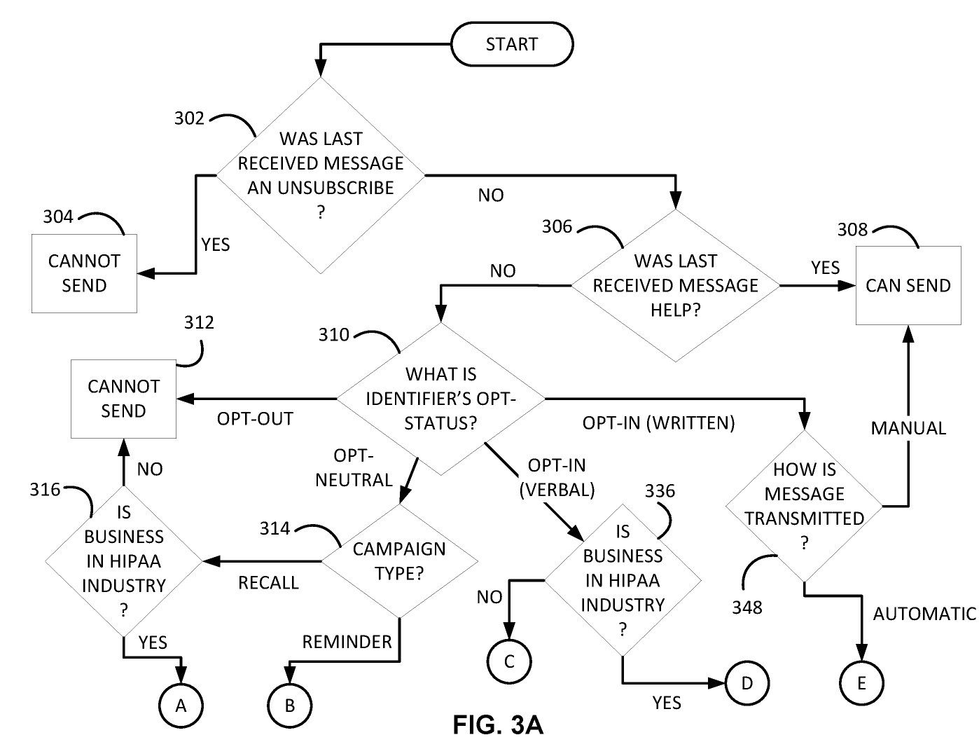

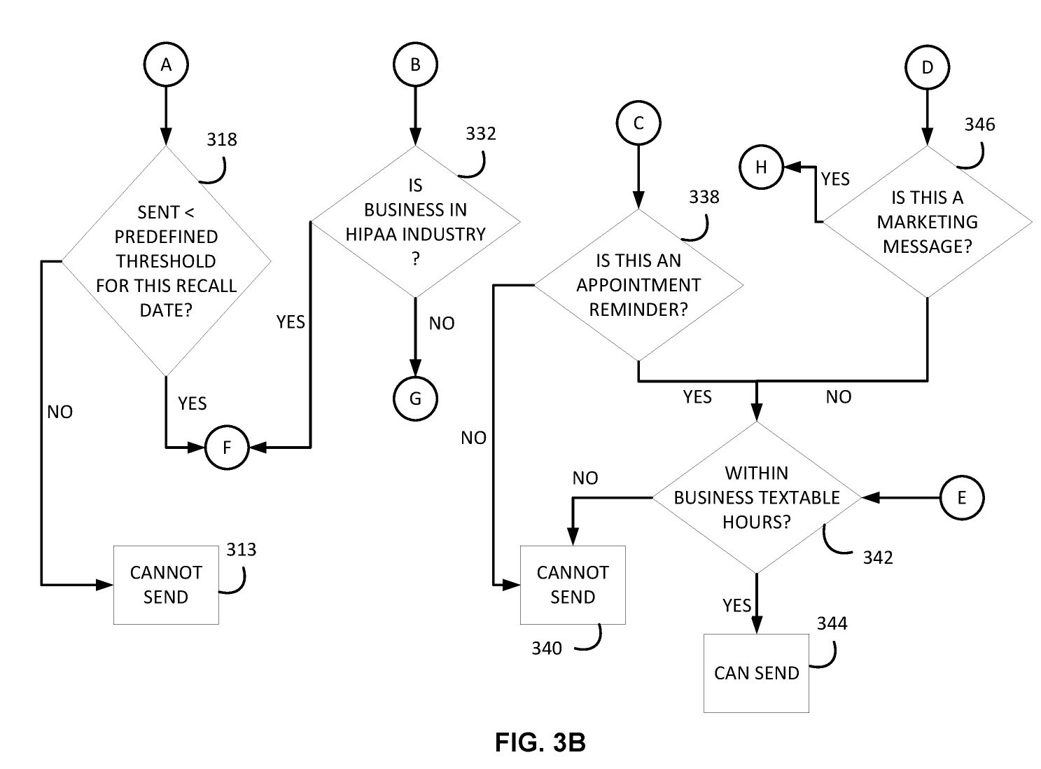

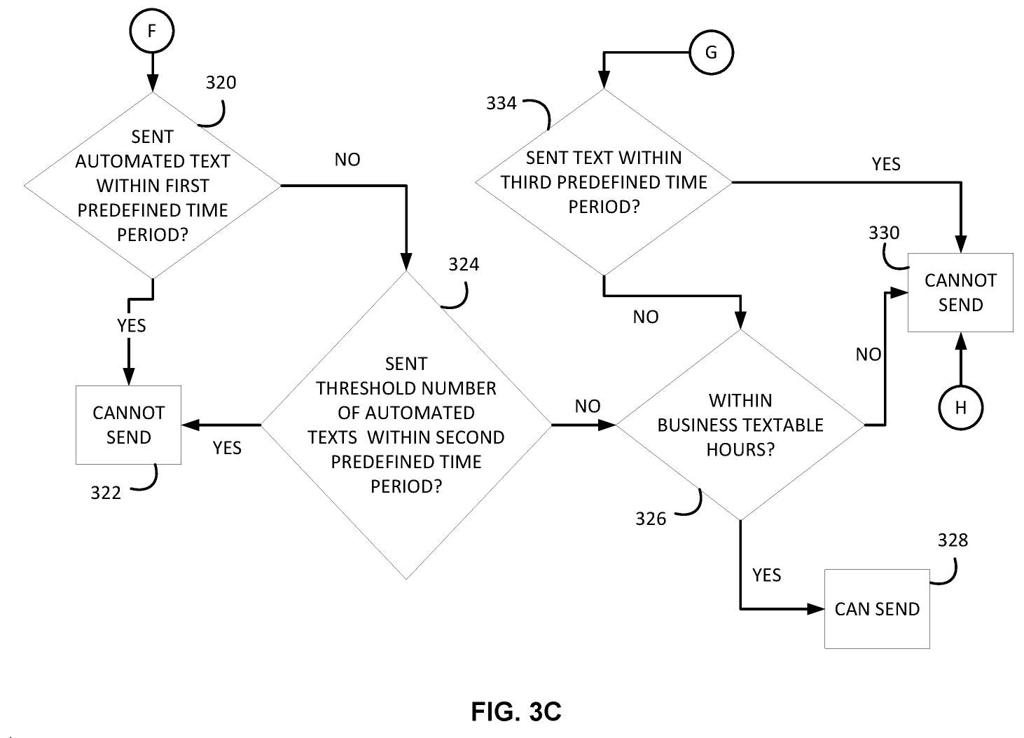

The management logic 106 is configured to provide a business the ability to configure rule-sets specific to the business. The management logic 106 may receive data from a business via an API comprising one or more new or altered rule-sets. As discussed above briefly, a rule-set is used by the management logic 106 to generate one or more workflows for a particular business. As will be discussed below in more detail with respect to at least FIGS. 3A-5, the workflows are used by the compliance logic 108 to determine whether transmission of a proposed communication to an intended recipient for delivery at a specified date and time would violate legislation and/or rules specific to the particular business. The management logic 106 may generate a workflow for one or more channels over which communications may be transmitted (e.g., a workflow for email, text messaging, phone calls, etc.).

Generated workflows are stored in the compliance database 110. The workflows themselves are composed of programming units which are maintained within compliance logic 108 and configuration data stored in the compliance database 110 which define the operating parameters of the programming units and the flow of control between them. (For example, a message-history-count programming unit can be configured to return a count of messages by time range and either by channel or by category and would return the count of messages.) The programming units may be used in multiple places in the workflow with different configurations. For example, a message-history-count programming unit could be used to determine whether a customer who is not opted in has received more than 3 reminder or recall text messages in a 7 day period and also used with a different configuration to check whether a customer who is opted in has received fewer than 8 text messages of any category in a one day time period.

The programming units may be predefined logic modules (e.g., developed by software developers). The configuration steps in a workflow may be either pre-generated by analysts or automatically generated by combining predefined configuration data elements based on requests received from a business via API. In addition, the management logic 106 may receive, from a business, a request for a determination as to whether the business may transmit a proposed communication to an intended recipient at a specified time of delivery. Upon receipt of a request, the management logic 106 passes the request to the compliance logic 108, which performs one or more analyses on the communication logic 106 and applicable communication metadata in order to make the requested determination as discussed below. The management logic 106 also returns reporting data, so that back office personnel can retrieve the reason why a particular communication either did or did not go out and see the history of the campaigns a customer has opted into or out of and the means they used to perform those opt-ins.

The compliance logic 108 is configured to perform several tasks associated with providing a response to a business's request for a determination as to whether a proposed communication to an intended recipient for delivery at a specified date and time will violate legislation and/or rules specific to the business. The compliance logic 108 may be configured to: (i) determine the workflow to be used in analyzing whether transmission of a proposed communication to an intended recipient for delivery at a specified date and time will violate legislation and/or rules specific to the business, (ii) retrieve metadata applicable to: the business (e.g., stored metadata associated with a particular business identifier, such as industry of the business, e.g., used in determining whether the business is within an industry governed by HIPAA or other regulations), the proposed communication (e.g., proposed date and time of delivery, category, and optionally, subcategory, of the proposed communication, channel over which the proposed communication is to be transmitted, etc.), the opt-status of the intended recipient, and the communication history between the business and the intended recipient, (iii) retrieve the applicable workflow from compliance database 110, (iv) analyze the retrieved workflow in light of the retrieved metadata to determine whether transmission of the proposed communication to the intended recipient for delivery at the specified date and time would violate legislation and/or rules specific to the particular business, and (v) transmit a notification to the business seeking to transmit the proposed communication. The analysis of the retrieved workflow in light of the retrieved metadata is comprised of one or more determinations set forth in the retrieved workflow as discussed in more detail with respect to at least FIGS. 3A-5.

The compliance CQ logic 112 is configured to analyze the CQ 114. The CQ 114 is a distributed messaging bus, into which businesses may write communications for transmission to intended recipients. In one embodiment, the CQ 114 may be a Kafka queue. Additionally, the CQ 114 is shown in FIG. 1 as being outside of the CCS 110 (e.g., located on a different server). However, it has been contemplated that the CQ 114 may be part of the CCS 100. In one embodiment, the CCS 100 (e.g., and its logic components), the CQ 114 and the legacy compliance system 116 (to be discussed below), may be communicatively coupled via the network 101. However, direct hardwire connections may be made between one or more of the CCS system 100 and the legacy compliance system 116 and/or the CCS system 100 and the CQ 114. The compliance CQ logic 112 analyzes the CQ 114 to determine transmission history (e.g., all communications transmitted to recipients). The compliance CQ logic 112 may store the transmission history in the compliance database 110 so that the transmission history is accessible by the compliance logic 108 for use in determining whether a proposed communication to an intended recipient for delivery at a specified date and time would violate legislation and/or rules specific to a business. For example, the compliance logic 108 may need to determine the number of communications transmitted to a particular recipient within a predetermined time period (e.g., the past seven days; however, the terms “predetermined time period” and “predefined time period” may be used to mean any time period) in traversing a workflow. In one embodiment, the compliance CQ logic 112 may actively retrieve data from the CQ 114 via a pull mechanism (e.g., query the CQ 114 for data). In an alternative embodiment, the compliance CQ logic 112 may be pushed data via direct communication from businesses via an API. Additionally, notices of subscriptions and/or unsubscribes from consumers may be posted to the CQ 114 for businesses to read and take action (e.g., add to a listserv), when applicable.

The legacy compliance system 116 may include a legacy compliance logic 118 and one or more legacy databases 120₁-120ᵢ (where i≥1). Because many systems adopting the CCS system 100 may already have a database of customer opt-in and opt-out requests (e.g., referred to as “legacy systems”), the CCS system 100 uses the legacy compliance system 116 to support importing campaign subscription data into the compliance database 110 as both a one-time transition to the new system, or a perpetual extraction, transformation, and load process that continually monitors subscription data in the legacy databases 120₁-120ᵢ and keeps it synchronized with the CCS system's compliance database 110.

The embodiment of FIG. 1 illustrates that that the CCS system 100 and the legacy compliance system 116 may be included within separate servers. However, it has been contemplated that the legacy compliance logic 118 and the legacy databases 120₁-120ᵢ may be included on the same server as the CCS 100.

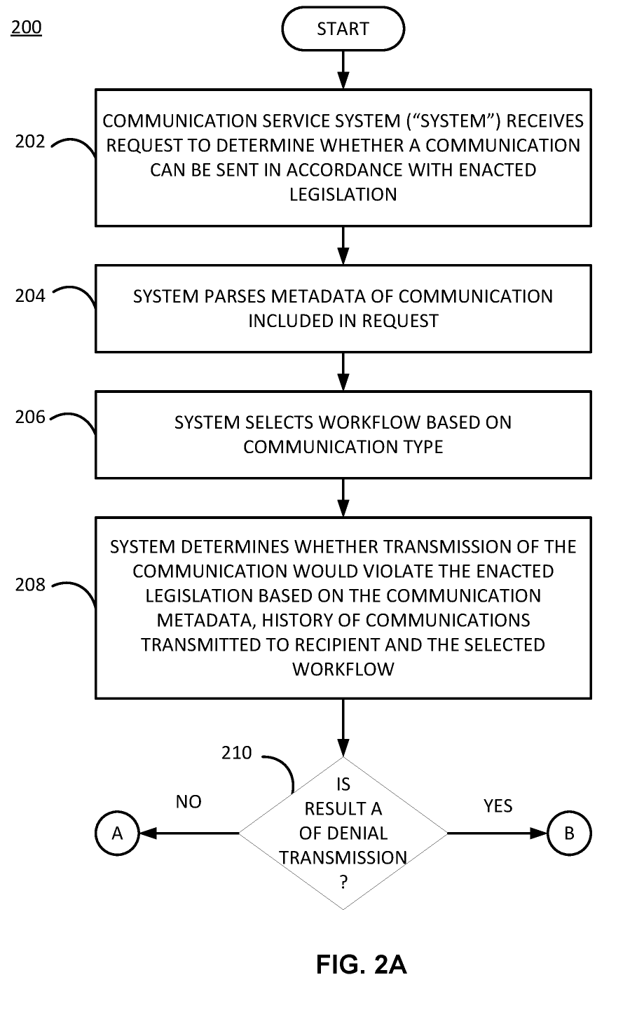

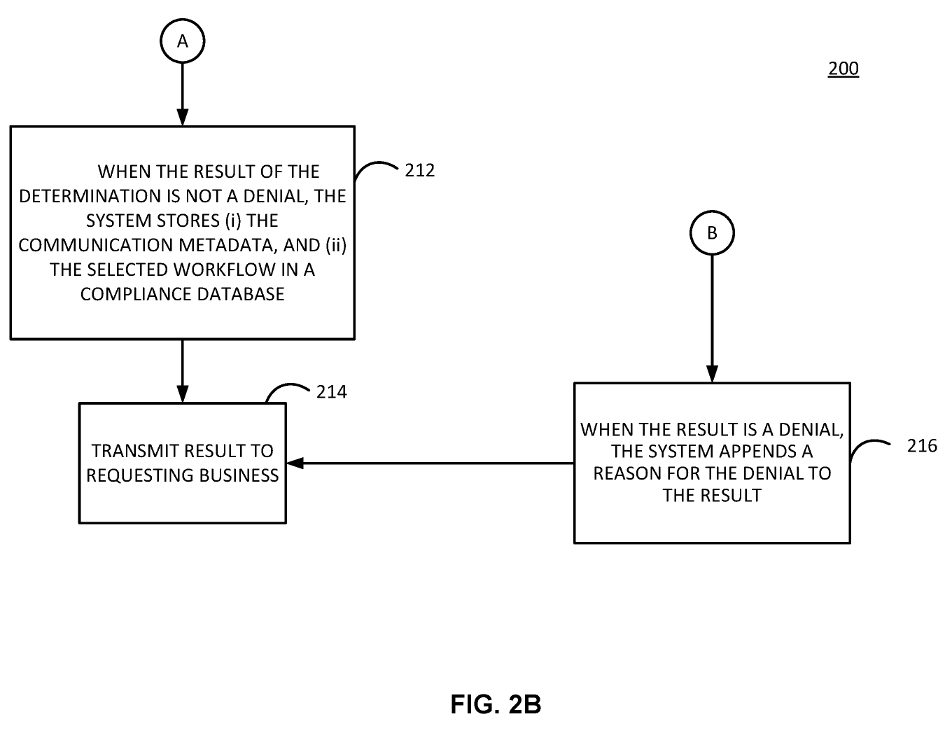

Referring now to FIGS. 2A-2B, an exemplary flow diagram of an analysis performed by the CCS system 100 of FIG. 1 to determine the compliance of transmitting a communication according to legislation and rules specific to a business is shown. Each block illustrated in FIGS. 2A-2B represents an operation performed in the method 200 of determining the compliance of transmitting a communication according to legislation and rules specific to the business. The method 200 begins when the CCS system 100 receives a request to determine whether a proposed communication may be transmitted to an intended recipient at a specific time and date for delivery according to legislation and/or rules specific to the business (block 202).

At block 204, the CCS system 100 parses the metadata of the proposed communication included the request. For example, the metadata of the proposed communication included in the request may comprise an identifier of the intended recipient, a time of delivery and date of delivery (collectively, “time of delivery”), a category of the communication, which may be broken down into numerous sub-categories—an example category may be a reminder and example sub-categories may include an advanced reminder, a two-day reminder with confirmation request, a day-of reminder, etc., and a channel over which the proposed communication is to be transmitted (e.g., an email, a text message, a phone call, etc.). Prior to parsing the metadata, the compliance logic 108 retrieves the metadata, which may be stored in one or more of the compliance database 110 and/or the communication queue 114.

At block 206, the CCS system 100 selects a workflow applicable to determining whether transmission of the proposed communication would violate legislation and/or rules specific to the business. Specifically, as discussed with respect to FIG. 1, the compliance logic 108 of the CCS system 100 determines the applicable workflow based on the metadata of the proposed communication included in the request.

At block 208, the CCS system 100 analyzes the selected workflow, performing one or more determinations based on the metadata of the proposed communication included in the request, the historical data of transmissions of communications between the business and the intended recipient to determine whether transmission of the proposed communication would violate legislation and/or rules specific to the business. Specifically, as discussed with respect to FIG. 1, the compliance logic 108 of the CCS system 100 performs the analysis to determine whether transmission of the proposed communication to the intended recipient for delivery at the specified date and time would violate legislation and/or a rule specific to the business.

When the compliance logic 108 determines that transmission of the proposed communication to the intended recipient for delivery at the specified time and time would not violate legislation and/or a rule specific to the business (no at block 210), the CCS system 100 stores (i) the communication metadata, and (ii) the selected workflow in the compliance data 110 as illustrated in FIG. 1 (block 212). At block 214, the CCS system 100 transmits the result of the determination to the requesting business.

When the compliance logic 108 determines that transmission of the proposed communication to the intended recipient for delivery at the specified time and time would violate legislation and/or a rule specific to the business (yes at block 210), the CCS system 100 appends a reason for denying the request to transmit the proposed communication (block 216). Specifically, when the CCS system 100 determines that transmission of the proposed communication to the intended recipient for delivery at the specified date and time would violate legislation and/or a rule specific to the business, the CCS system 100 provides the business with the reason for the violation (e.g., whether the intended recipient has already received a maximum number of a certain type of communication (e.g., may be category-specific) within a predetermined time period under legislation). At block 214, the CCS system 100 transmits the result to the business in the form of a notification. In this scenario, i.e., following a determination that such a transmission would violate legislation and/or a rule specific to the business, the result includes the reason for the potential violation as appended to the result in block 216.

### Permissibility of Transmitting a Text Message—Workflow Version 1

Referring now to FIGS. 3A-3C, an exemplary flowchart illustrating a workflow for determining the permissibility of transmitting a text message to an intended recipient based on regulation guidelines is shown. The flowchart of FIGS. 3A-3C illustrates a method 300, e.g., one exemplary workflow, that determines whether a text message may be transmitted to an intended recipient within a designated time period (e.g., within an hour of determining a result as to whether the text message may be transmitted). Each block illustrated in FIGS. 3A-3C represents an operation performed in the method 300 of determining the permissibility of transmitting a text message to an intended recipient based on regulation guidelines. Herein, the method 300 starts by determining whether the last message received from the intended recipient was an unsubscribe message (block 302). In one embodiment, an unsubscribe message may include a singular “unsubscribe keyword” such as “stop,” “stopall,” “unsubscribe,” “end,” “quit,” “cancel.” Additionally, the use of other forms of unsubscribe messages have been contemplated such as receipt of input entered by the intended recipient to an internet browser (e.g., via text box, radio dial selection, or the like).

When a result of the determination as to whether the last message received from the intended recipient was an unsubscribe message (yes at block 302), the method 300 results in a determination that the text message cannot be sent to the intended recipient (block 304). However, in some embodiments, a separate method of communication (e.g., email) may be used to transmit a communication to the intended recipient confirming the opt-out selection and including opt-in instructions. When the result of the determination as to whether the last message received from the intended recipient was not an unsubscribe message (no at block 302), a determination is made as to whether the last message received from the intended recipient was a help message (block 306). In one embodiment, a help message may include a singular “help keyword” such as “help,” or “info.” Additionally, as discussed above, the use of other forms of help messages have been contemplated similar to additional unsubscribe message forms.

When a result of the determination as to whether the last message received from the intended recipient was a help message (yes at block 306), the method 300 results in a determination that the text message can be sent to the intended recipient (block 308). When the result of the determination as to whether the last message received from the intended recipient was not a help message (no at block 306), a determination is made as to the “opt-status” of the intended recipient (block 310). The term “opt-status” may refer to: (i) an opt-out; (ii) an opt-neutral (e.g., no explicit opt-in or opt-out); (iii) a verbal opt-in; or (iv) a written opt-in. In one embodiment, the opt-status may be stored according to an identifier of the intended recipient (e.g., a phone number, an email address, or other alpha-numeric combination).

Opt-Status: Opt-Out

When the result of the determination as to whether the opt-status of the intended recipient is opt-out (block 310), the method 300 results in a decision that the text message cannot be transmitted to the intended recipient at the specified time of delivery (block 312). In one embodiment, the opt-status may be stored corresponding to a phone number or other recipient identifier (e.g., a user name) that may in turn be stored corresponding to a customer (e.g., an intended recipient).

Opt-Status: Opt-Neutral

When the result of the determination as to whether the opt-status of the intended recipient is opt-neutral (block 310), a determination is made as to the campaign type (e.g., appointment reminder, missed-appointment recall, post-appointment follow-up, birthday/holiday, etc.) of the message to be transmitted (block 314). Such a determination is made via analysis of communication metadata retrieved by the compliance logic 108, as discussed above. Examples of campaign types may include, but are not limited or restricted to, reminders, recalls, and/or post-appointment follow-up. In some embodiments, a reminder includes a communication in advance of a scheduled appointment to confirm an intended attendance of a client or customer and remind the client or customer of the date, time and location of the appointment. A recall may include a communication prompting a client or customer to schedule an appointment within a given time frame based on recommended service/treatment intervals. The types of appointments and/or service/treatment intervals may vary by industry. One example may include an oil change prompt within the automotive industry every 3 months. A second example may include a dental cleaning reminder every 6 months. Recalls may also encompass treatment plans that are specific to individuals, and may be manually entered by a doctor in a practice management system communicatively coupled to the CCS system 100. For example, a pregnant woman may be prompted to schedule a specific series of prenatal visits at pre-set intervals. A post-appointment follow-up may include a communication thanking a customer for their visit and requesting feedback about their satisfaction with that visit.

When the result of the determination as to the campaign type of the message is “recall” (block 314), a determination is made as to whether the business proposing to send the message is in a HIPAA industry (block 316). The determination as to whether the business proposing to send the message is in a HIPAA industry is performed via an analysis of communication metadata, specifically, metadata associated with the business identifier of the business proposing to send the message. The business identifier may identify an industry type of the business and the compliance logic 108, as discussed above, uses one or more predetermined rule sets to determine whether the industry type of the business is covered by HIPAA regulations. It should be noted that the use of HIPAA in this embodiment is not intended to be limiting and may be replaced with any set of regulations. When the result of the determination as to whether the business proposing to send the message is in a HIPAA industry is “no” (block 316), the method 300 results in a decision that the text message cannot be transmitted to the intended recipient at the specified time of delivery (block 312). When the result of the determination as to whether the business proposing to send the message is in a HIPAA industry is “yes” (block 316), a determination is made as to whether less than a predefined number of text messages has been transmitted from the business with respect to a specified recall date (e.g., a prompt for follow-up care subsequent to a patient's appointment, as in block 318). In one embodiment, the predefined number of text messages may be two. However, in other embodiments, other numbers may be used (e.g., more or less than two). Additionally, legislation may determine or influence the predefined number (e.g., to remain compliant in applicable situations). The determination of the threshold of text messages transmitted from the business with respect to a specified recall data may performed by the compliance logic 108 querying the compliance DB 110. In an alternative embodiment, the determination of the threshold of text messages transmitted from the business with respect to a specified recall data may performed by analyzing the communication queue to determine communication history between the intended recipient and the business via the compliance CQ logic 112. When the result of the determination as to whether less than a predefined threshold of text messages has been transmitted from the business with respect to the specified recall date is “no” (block 318), the method 300 results in a decision that the text message cannot be transmitted to the intended recipient at the specified time of delivery (block 313).

When the result of the determination as to whether a predefined number of text messages has been transmitted from the business with respect to a specified recall date is “yes” (block 318), a determination is made as to whether the intended recipient has received an automated text message from the business within a first predefined time period (block 320). Specifically, current legislation may define messaging limits applicable to automated messages. However, the disclosure is not intended to be limited to automated messages. Instead, the CCS system 100 may be updated to adjust, add or remove workflows upon adjustments in legislation. Thus, in one embodiment, the CCS system 100, e.g., the management logic 106, may receive updates via the network 101 and subsequently perform processing to adjust or remove stored workflows or generate new workflows based on the update (e.g., which may be the result of an adjustment in legislation). In one embodiment, a predefined time period may be determined relative to a predefined location (e.g., the business's headquarters or the intended recipient's physical address, if known). When the result of the determination as to whether the intended recipient has received an automated text message from the business within the first predefined time period is “no” (block 320), a determination is made as to whether the intended recipient has received a threshold number of automated text messages from the business within a second predefined time period (block 324). In one embodiment, the second predefined time period may be seven days prior to the current day relative to a predefined location. When the result of the determination as to whether the intended recipient has received a threshold number of automated text messages from the business within the second predefined time period is “yes” (block 324), the method 300 results in a decision that the text message cannot be transmitted to the intended recipient within the predefined time period (block 322).

When the result of the determination as to whether the intended recipient has received a threshold number of automated text messages from the business within the second predefined time period is “no” (block 324), a determination is made as to whether the time of delivery of the text message is within a predefined timeframe, which may be business textable hours (block 326). In one embodiment, business textable hours may refer to weekdays from 9 am-5 pm relative to a location of the intended recipient, or alternatively, relative to a location of the headquarters of the business. In other embodiments, other time periods may be defined. Additionally, business textable hours may be defined to exclude predetermined days (e.g., holidays). When the result of the determination as to whether the time of delivery of the text message is within the business textable hours is “no” (block 326), the method 300 results in a decision that the text message cannot be transmitted to the intended recipient within the predefined time period (block 330). When the result of the determination as to whether the time of delivery of the text message is within the business textable hours is “yes” (block 326), the method 300 results in a decision that the text message can be transmitted to the intended recipient within the predefined time period (block 328).

Referring back to block 320, when the result of the determination as to whether the intended recipient has received an automated text message from the business within the first predefined time period is “yes” (block 320), the method 300 results in a decision that the text message cannot be transmitted to the intended recipient within the predefined time period (block 322).

Referring back to block 314 of FIG. 3A, when the result of the determination as to the campaign type of the message is “reminder” (block 314), a determination is made as to whether the business proposing to send the message is in a HIPAA industry (block 332). When the result of the determination as to whether the business proposing to send the message is in a HIPAA industry is “no” (block 332), a determination is made as to whether the intended recipient has received a text message from the business within a third predefined time period, e.g., ten days (block 334). As discussed above, the determinations made by the CCS 100 are not limited to consideration of HIPAA but may include other regulations and/or organizations.

When the result of the determination as to whether the intended recipient has received a text message from the business within a third predefined time period is “no” (block 334), a determination is made as to whether the time of delivery of the text message is within business textable hours as discussed above with respect to block 316 (block 326). When the result of the determination as to whether the intended recipient has received a text message from the business within a third predefined time period is “yes” (block 334), the method 300 results in a decision that the text message cannot be transmitted to the intended recipient within the predefined time period (block 330).

Referring back to block 332, when the result of the determination as to whether the business proposing to send the message is in a HIPAA industry is “yes” (block 332), a determination is made as to whether the intended recipient has received an automated text message from the business within the first predefined time period as discussed above (block 320).

Opt-Status: Verbal Opt-in

Referring back to block 310, when the result of the determination as to whether the opt-status of the intended recipient is a verbal opt-in (block 310), a determination is made as to whether the business proposing to send the message is in a HIPAA industry (block 336). When the result of the determination as to whether the business proposing to send the message is in a HIPAA industry is “no” (block 336), a determination is made as to whether the text message is an appointment reminder (block 338). When the result of the determination as to whether the text message is an appointment reminder is “yes” (block 338), a determination is made as to whether the time of delivery of the text message is within business textable hours (block 342). When the result of the determination as to whether the time of delivery of the text message is within the business textable hours is “no” (block 342), the method 300 results in a decision that the text message cannot be transmitted to the intended recipient within the predefined time period (block 340). When the result of the determination as to whether the time of delivery of the text message is within the business textable hours is “yes” (block 342), the method 300 results in a decision that the text message can be transmitted to the intended recipient within the predefined time period (block 344).

Referring back to block 336, when the result of the determination as to whether the business proposing to send the message is in a HIPAA industry is “yes” (block 336), a determination is made as to whether the text message is a marketing message (block 346). When the result of the determination as to whether the text message is a marketing message is “yes” (block 346), the method 300 results in a decision that the text message cannot be transmitted to the intended recipient within the predefined time period (block 330). When the result of the determination as to whether the text message is a marketing message is “no” (block 346), a determination is made as to whether a time of delivery of the text message is within business textable hours as discussed above (block 342).

Opt-Status: Written Opt-in

Referring back to block 310, when the result of the determination as to whether the opt-status of the intended recipient is a written opt-in (block 310), a determination is made as to the methodology of generating the text message (block 348). When the result of the determination as to the methodology of generating the text message is a “manual” (block 348), the method 300 results in a decision that the text message can be transmitted to the intended recipient within the predefined time period (block 344). When the result of the determination as to the methodology of generating the text message is a “automatic” (block 348), a determination is made as to whether the time of delivery of the text message is within business textable hours as discussed above (block 342).

### Permissibility of Transmitting an Text Message—Workflow Version 2

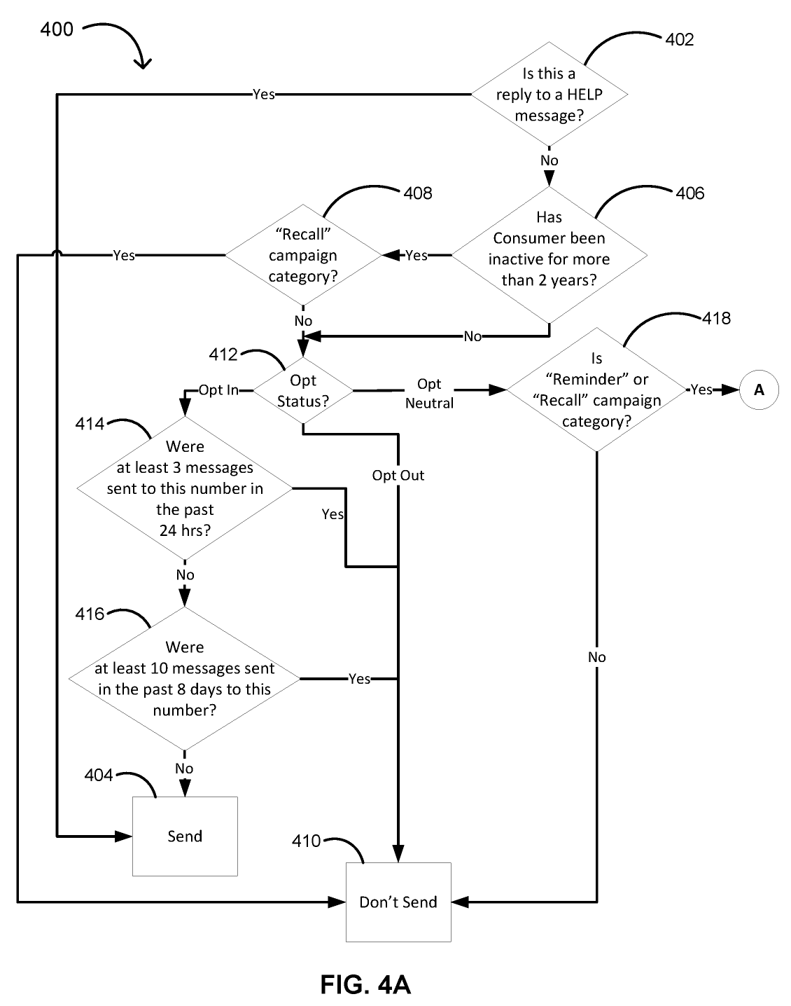

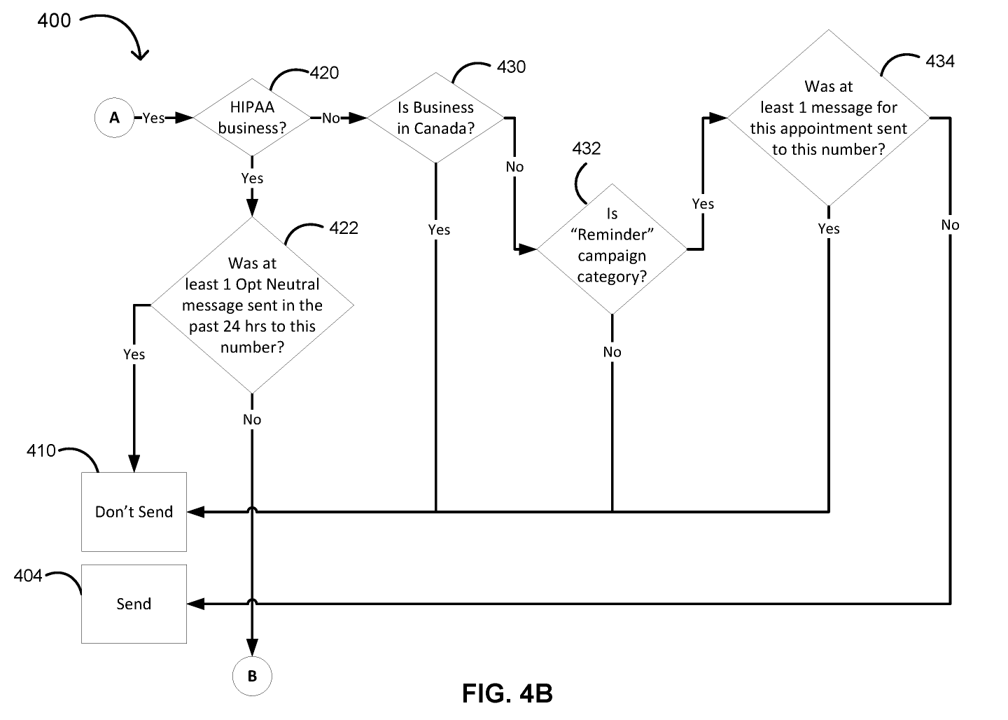

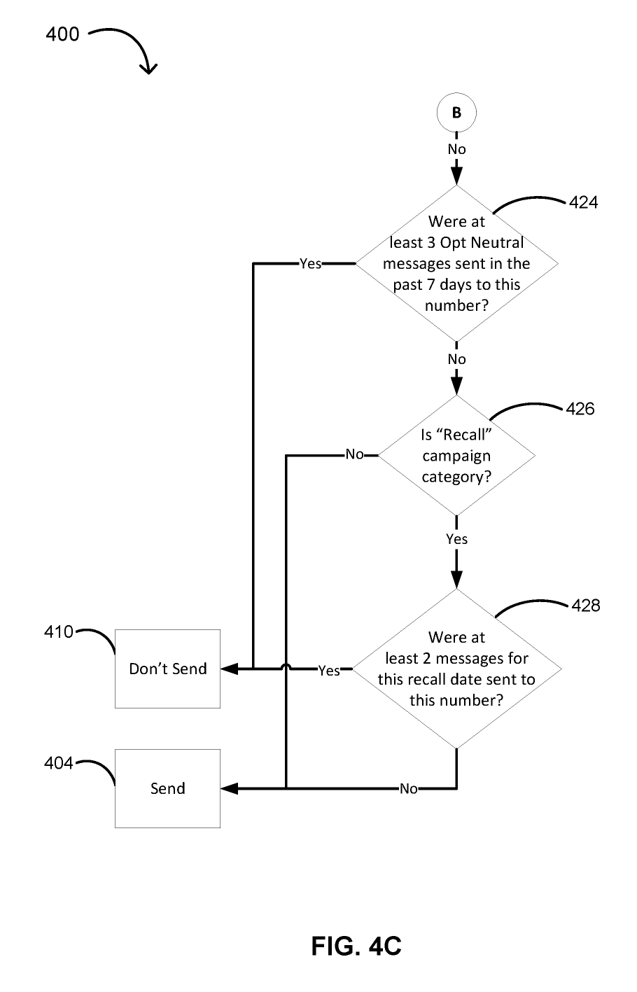

Referring now to FIGS. 4A-4C, a second exemplary flowchart illustrating a workflow for determining the permissibility of transmitting a text message to an intended recipient based on regulation guidelines is shown. The flowchart of FIGS. 4A-4C illustrates a method 400, e.g., a second exemplary workflow for determining whether a text message may be transmitted to an intended recipient within a designated time period (e.g., within an hour of determining a result as to whether the text message may be transmitted). Each block illustrated in FIGS. 4A-4C represents an operation performed in the method 400 of determining the permissibility of transmitting a text message to an intended recipient based on regulation guidelines via the second workflow. Herein, the method 400 starts when a request for a determination as to the permissibility of transmitting a text message to an intended recipient at a specified time of delivery is received from a particular business. Following the receipt of the request by the business, a determination is made as to whether the proposed text message is a reply to a help message (block 402). When the result of the determination as to whether is a reply to a help message is “yes” (block 402), the method 400 results in a decision that the text message may be transmitted to the intended recipient at the specified time of delivery (block 404). When the result of the determination as to whether is a reply to a help message is “no” (block 402), a determination is made as to whether the intended recipient has been inactive with respect to the requesting business for a predetermined amount of time (e.g., illustrated as two or more years but may be longer or shorter period of time) (block 406). When the result of the determination as to whether the intended recipient has been inactive with respect to the requesting business for the predetermined amount of time is “yes” (block 406), a determination is made as to whether the text message falls within a “recall” campaign category (block 408).

When the result of the determination as to whether the text message falls within a “recall” campaign category is “yes” (block 408), the method 400 results in a decision that the text message cannot be transmitted to the intended recipient at the specified time of delivery (block 410). When the result of the determination as to whether the text message falls within a “recall” campaign category is “no” (block 408), the method 400 proceeds to making a determination as to the opt-status of the intended recipient (block 412). Additionally, when the result of the determination as to whether the intended recipient has been inactive with respect to the requesting business for a predetermined amount of time is “no” (block 406), the method 400 proceeds to making a determination as to the opt-status of the intended recipient (block 412). In this exemplary workflow version, the term “opt-status”may refer to: (i) an opt-in; (ii) an opt-out; or (iii) an opt-neutral (e.g., no explicit opt-in or opt-out).

Opt-Status: Opt-in

When the result of the determination as to whether the opt-status of the intended recipient is opt-in (block 412), a determination is made as to whether a predefined number of text messages have been sent to the intended recipient within a second predetermined time period (block 414). Herein, the predefined number of text messages is illustrated as being three text messages and the second predetermined time period is illustrated as being 24 hours; however, the disclosure is not intended to be so limited and any number of text messages may be used as well as any time period. When the result of the determination as to whether at least the predefined number of text messages have been sent to the intended recipient within the second predetermined time period is “yes” (block 414), the method 400 results in a decision that the text message cannot be transmitted to the intended recipient within the predefined time period (block 410).

When the result of the determination as to whether at least the predefined number of text messages have been sent to the intended recipient within the second predetermined time period is “no” (block 414), a determination is made as to whether a second predefined number of text messages have been sent to the intended recipient within a third predetermined time period (block 416). As with the predefined number of text messages and the second predetermined time period, any number of text messages and any time period may be used for the second predefined number of text message and the third predetermined time period, respectively.

When the result of the determination as to whether at least the second predefined number of text messages have been sent to the intended recipient within the third predetermined time period is “yes” (block 416), the method 400 results in a decision that the text message cannot be transmitted to the intended recipient within the predefined time period (block 410).

When the result of the determination as to whether at least the second predefined number of text messages have been sent to the intended recipient within the third predetermined time period is “no” (block 416), the method 400 results in a decision that the text message can be transmitted to the intended recipient within the predefined time period (block 404).

Opt-Status: Opt-Out

When the result of the determination as to whether the opt-status of the intended recipient is opt-out (block 412), the method 400 results in a decision that the text message cannot be transmitted to the intended recipient within the predefined time period (block 410).

Opt-Status: Opt-Neutral

When the result of the determination as to whether the opt-status of the intended recipient is opt-neutral (block 412), a determination is made as to whether the text message falls within either a “recall” or a “reminder” campaign category (block 418).

When the result of the determination as to whether the text message falls within either a “recall” or a “reminder” campaign category is “no” (block 418), the method 400 results in a decision that the text message cannot be transmitted to the intended recipient at the specified time of delivery (block 410). When the result of the determination as to whether the text message falls within either a “recall” or a “reminder” campaign category is “yes” (block 418), a determination is made as to whether the requesting business is designated as a HIPAA business (that is, businesses who are subject to the United States government's Health Insurance Portability and Accountability Act, block 420). When the result of the determination as to whether the requesting business is designated as a HIPAA business is “yes” (block 420), a determination is made as to whether at least one text message has been sent to the intended recipient while having an “opt-neutral” status within the past 24 hours (however, other predetermined time periods may be used according to the workflow) (block 422). When the result of the determination as to whether at least one text message has been sent to the intended recipient while having an “opt-neutral” status within the past 24 hours is “yes” (block 420), the method 400 results in a decision that the text message cannot be transmitted to the intended recipient at the specified time of delivery (block 410).

When the result of the determination as to whether at least one text message has been sent to the intended recipient while having an “opt-neutral” status within the past 24 hours is “no” (block 420), a determination is made as to whether at least a predefined number of text messages, e.g., illustrated as three, have been sent to the intended recipient within a predetermined time period, e.g., illustrated as seven days (block 424). When the result of the determination as to whether at least the predefined number of text messages have been sent to the intended recipient within the predetermined time period is “yes” (block 424), the method 400 results in a decision that the text message cannot be transmitted to the intended recipient at the specified time of delivery (block 410). When the result of the determination as to whether at least the predefined number of text messages have been sent to the intended recipient within the predetermined time period is “no” (block 424), a determination is made as to whether the text message falls within a “recall” campaign category (block 426). When the result of the determination as to whether the text message falls within a “recall” campaign category is “no” (block 426), the method 400 results in a decision that the text message can be transmitted to the intended recipient at the specified time of delivery (block 404). When the result of the determination as to whether the text message falls within a “recall” campaign category is “yes” (block 426), a determination is made as to whether at least a preset number of recall text messages, e.g., illustrated as two, have been sent to the intended recipient from the requesting business.

When the result of the determination is made as to whether at least a preset number of recall text messages have been sent to the intended recipient from the requesting business is “yes” (block 428), the method 400 results in a decision that the text message cannot be transmitted to the intended recipient at the specified time of delivery (block 410). When the result of the determination is made as to whether at least a preset number of recall text messages have been sent to the intended recipient from the requesting business is “no” (block 428), the method 400 results in a decision that the text message can be transmitted to the intended recipient at the specified time of delivery (block 404).

Referring back to block 420, when the result of the determination as to whether the requesting business is designated as a HIPAA business is “no” (block 420), a determination is made as to whether the requesting business is an entity legally domiciled in Canada (block 430). The determination as to the country in which the requesting business is located is made via an analysis of metadata regarding each business provided to the CCS system 100 via APIs in the Management Logic 106 and stored in the Compliance DB 110 (such metadata includes at least contact and address information for each participating business, from which the country of origin of a communication may be extracted). It should be noted that the disclosure is not limited to a determination as to whether the business is located in Canada but such a determination may be made for any country, state, or geographic region or organization (e.g., European Union) as set forth in a workflow. When the result of the determination as to whether the requesting business is located in Canada is “yes” (block 430), the method 400 results in a decision that the text message cannot be transmitted to the intended recipient at the specified time of delivery (block 410). When the result of the determination as to whether the requesting business is located in Canada is “no” (block 430), a determination is made as to whether the text message falls within a “reminder” campaign category (block 432). When the result of the determination as to whether the text message falls within a “reminder” campaign category is “no” (block 432), the method 400 results in a decision that the text message cannot be transmitted to the intended recipient at the specified time of delivery (block 410).

When the result of the determination as to whether the text message falls within a “reminder” campaign category is “yes” (block 432), wherein the reminder is for a specified appointment, a determination is made as to whether at least one text message has previously been sent from the requesting business to the intended recipient regarding the specified appointment (although predetermined numbers other than one may be used in the determination) (block 434). When the result of the determination as to whether at least one text message has previously been sent from the requesting business to the intended recipient regarding the specified appointment is “no” (block 434), the method 400 results in a decision that the text message can be transmitted to the intended recipient within the predefined time period (block 404).

When the result of the determination as to whether at least one text message has previously been sent from the requesting business to the intended recipient regarding the specified appointment is “yes” (block 434), the method 400 results in a decision that the text message cannot be transmitted to the intended recipient at the specified time of delivery (block 410).

### Permissibility of Transmitting an Email

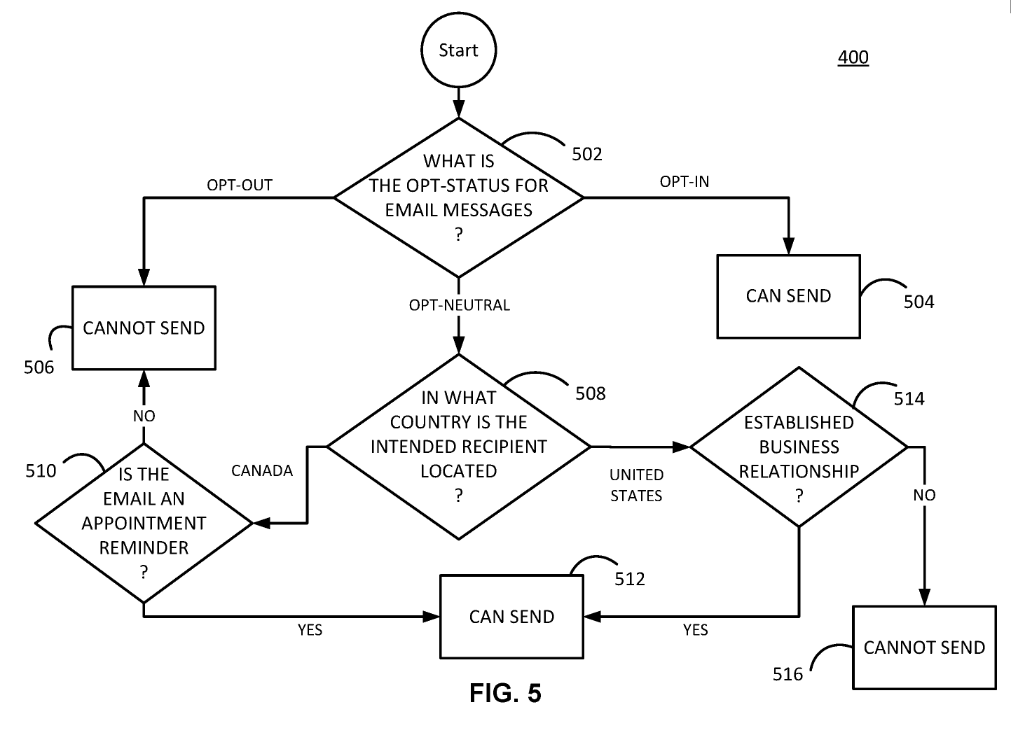

Referring to FIG. 5, an exemplary flowchart illustrating a workflow for determining the permissibility of transmitting an email communication is shown. The flowchart of FIG. 5 illustrates a method 500, e.g., one exemplary workflow, that determines whether an email message may be transmitted to an intended recipient within a designated time period (e.g., within an hour of determining a result as to whether the email message may be transmitted). Each block illustrated in FIG. 5 represents an operation performed in the method 500 of determining the permissibility of transmitting an email message to an intended recipient based on regulation guidelines. Herein, the method 500 starts when a request for a determination as to the permissibility of transmitting an email to an intended recipient at a specified time of delivery is received from a particular business. Following the receipt of the request by the business, a determination is made as to the “opt-status” of the intended recipient with respect to emails (block 502).

Opt-Status: Opt-Out

When the result of the determination as to whether the opt-status of the intended recipient is opt-out (block 502), the method 500 results in a decision that the text message cannot be transmitted to the intended recipient within the predefined time period (block 506).

Opt-Status: Opt-Neutral

When the result of the determination as to whether the opt-status of the intended recipient is opt-neutral (block 502), a determination is made as to the country in which the intended recipient is located (block 508). The determination as to the country in which the intended recipient is located is made via an analysis of metadata.

When the result of the determination as to whether the country in which the intended recipient is located is “Canada” (block 508), a determination is made as to whether the email is an appoint reminder (block 510). The embodiment should not be limited to the countries listed herein but may apply to any one or more countries, states, and/or geographic locations. When the result of the determination as to whether the email is an appoint reminder is “yes” (block 510), the method 500 results in a decision that the text message can be transmitted to the intended recipient within the predefined time period (block 512). When the result of the determination as to whether the email is an appoint reminder is “no” (block 510), the method 500 results in a decision that the text message cannot be transmitted to the intended recipient within the predefined time period (block 506). As discussed above, workflows are generated according to legislation, for example, Canada's CASL.

When the result of the determination as to whether the country in which the intended recipient is located is “United States” (block 508), a determination is made as to whether the intended recipient has an established business relationship with the business proposing to transmit the email (block 514). The term “established business relationship” may generally refer to an association between two parties based on (i) negotiations regarding a commercial transaction, (ii) an already agreed-upon commercial transaction, (iii) an ongoing commercial transaction, or the like. When the result of the determination as to whether the intended recipient has an established business relationship with the business proposing to transmit the email is “yes” (block 514), the method 500 results in a decision that the text message can be transmitted to the intended recipient within the predefined time period (block 512). When the result of the determination as to whether the intended recipient has an established business relationship with the business proposing to transmit the email is “no” (block 514), the method 500 results in a decision that the text message cannot be transmitted to the intended recipient within the predefined time period (block 516).

Opt-Status: Opt-in

When the result of the determination as to whether the opt-status of the intended recipient is opt-in (block 502), the method 500 results in a decision that the text message can be transmitted to the intended recipient within the predefined time period (block 504).

Methodology for Consumer Opt-Out

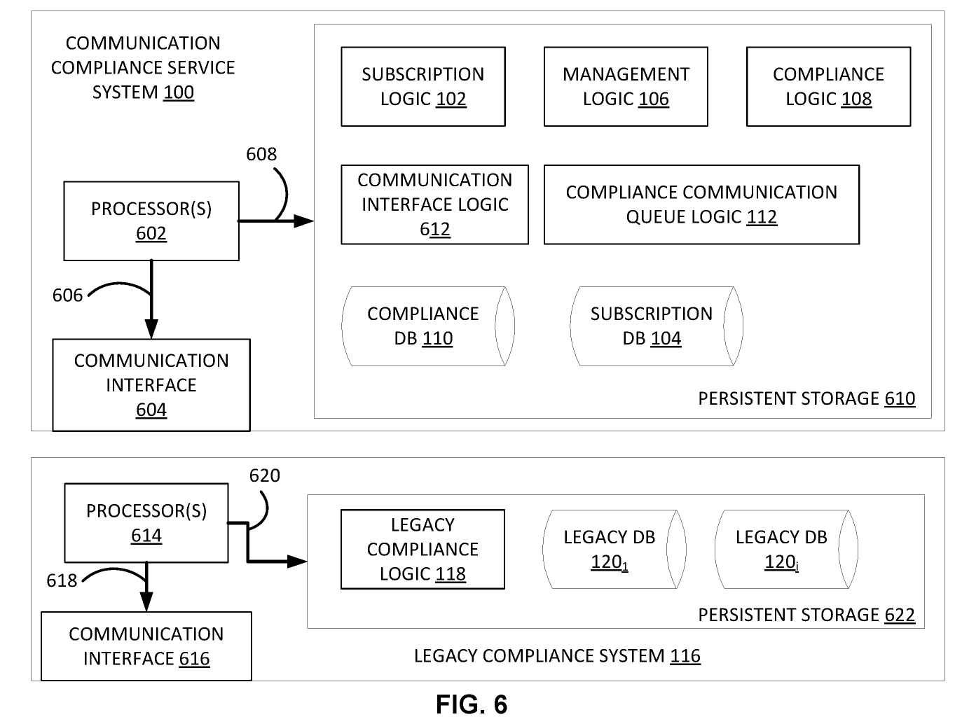

Referring to FIG. 6, logical representations of the Communication Compliance Service (CC S) system and the legacy compliance system are shown. The CCS 100, in one embodiment, may be stored on a non-transitory computer-readable storage medium of a server device including circuitry, namely one or more processors 602 that are coupled to a communication interface 604 via a first transmission medium 606. The communication interface 604, in combination with a communication interface logic 612, enables communications with external network devices and/or other network appliances to receive updates for the CCS 100 as well as information, such as requests for determinations as to whether transmission of a proposed electronic message will violate enacted legislation. According to one embodiment of the disclosure, the communication interface 604 may be implemented as a physical interface including one or more ports for wired connectors. Additionally, or in the alternative, the communication interface 604 may be implemented with one or more radio units for supporting wireless communications with other electronic devices. The communication interface logic 612 may include logic for performing operations of receiving and transmitting one or more objects via the communication interface 604 to enable communication between the CCS 100 and network devices via a network (e.g., the internet) and/or cloud computing services, not shown.

The processor(s) 602 is further coupled to a persistent storage 610 via a second transmission medium 608. According to one embodiment of the disclosure, the persistent storage 610 may include the following logic as software modules: the subscription logic 102, the management logic 106, the compliance logic 108, the compliance communication queue logic 112 and the communication interface logic 612. The operations of these software modules, upon execution by the processor(s) 602, are described above. The compliance database 110 and the subscription database each include stored data for access by the compliance logic 108 and the subscription logic 102, respectively.

In addition, the legacy compliance system 116, in one embodiment, may be stored on a non-transitory computer-readable storage medium of a second server device including circuitry, namely one or more processors 614 that are coupled to a communication interface 616 via a first transmission medium 618, the communication interface 616 operating in a similar manner as to the communication interface 604 discussed above. The processor(s) 614 is further coupled to a persistent storage 622 via a second transmission medium 620. According to one embodiment of the disclosure, the persistent storage 622 may include the following logic as software modules: the legacy compliance logic 118, and the communication interface logic 624, not shown. The operations of these software modules, upon execution by the processor(s) 614, are described above similar to those with respect to the CCS 100. The legacy databases 120₁-120ᵢ, each include stored data for access by the legacy compliance logic 118. Of course, it is contemplated that some or all of this logic, in either the CCS 100 and/or the legacy compliance system 116 may be implemented as hardware, and if so, such logic could be implemented separately from each other.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. An automated system for determining compliance of one or more regulations according to transmission of a proposed communication message to an intended recipient at a specified time of delivery, the system comprising:
a server device including one or more processors, a non-transitory computer-readable storage medium and instructions stored thereon, the instructions being executable by the one or more processors to perform operations including:
receiving, from a business, a request for a determination as to whether transmission of the proposed communication message to the intended recipient at the specified time of delivery would violate the one or more regulations;
responsive to receiving the request, retrieving business metadata of the business and proposed communication message metadata;
parsing the proposed communication message metadata to determine a communication type;
selecting a workflow from a set of workflows based on the communication type; and
determining whether transmission of the proposed communication message to the intended recipient at the specified time of delivery would violate the one or more regulations based on an analysis of the business metadata and the proposed communication message metadata according to the selected workflow.

2. The automated system of claim 1, wherein the communication type is one of an email, a short message service (SMS) text message, or a telephone call.

3. The automated system of claim 1, wherein each workflow of the set of workflows is a logic flow that includes one or more of a set of (i) logical steps, (ii) operations, (iii) processes, (iv) determinations, or (v) analyses.

4. The automated system of claim 3, wherein the logic flow includes one or more predetermined rule sets.

5. The automated system of claim 1, wherein the business includes one of an individual, a group of individuals, an unincorporated association, a limited or general partnership, a corporation, or other business entity.

6. The automated system of claim 1, wherein the proposed communication message metadata includes an identifier of the business, an identifier of the intended recipient, the time of delivery and the communication type.

7. The automated system of claim 1, further comprising:
responsive to determining transmission of the proposed communication message to the intended recipient at the specified time of delivery would violate the one or more regulations, transmitting a denial response to the business including a reason for violation.

8. The automated system of claim 1, further comprising:
responsive to determining transmission of the proposed communication message to the intended recipient at the specified time of delivery would not violate the one or more regulations, transmitting an approval response to the business, and storing (i) the request and (ii) a version of the selected workflow used in whether transmission of the proposed communication message to the intended recipient at the specified time of delivery would violate the one or more regulations.

9. A non-transitory computer readable storage medium having stored thereon instructions, the instructions being executable by one or more processors to perform operations including:
receiving, from a business, a request for a determination as to whether transmission of the proposed communication message to the intended recipient at the specified time of delivery would violate the one or more regulations;
responsive to receiving the request, retrieving business metadata of the business and proposed communication message metadata;
parsing the proposed communication message metadata to determine a communication type;
selecting a workflow from a set of workflows based on the communication type; and
determining whether transmission of the proposed communication message to the intended recipient at the specified time of delivery would violate the one or more regulations based on an analysis of the business metadata and the proposed communication message metadata according to the selected workflow.

10. The non-transitory computer readable storage medium of claim 9, wherein the communication type is one of an email, a short message service (SMS) text message, or a telephone call.

11. The non-transitory computer readable storage medium of claim 9, wherein each workflow of the set of workflows is a logic flow that includes one or more of a set of (i) logical steps, (ii) operations, (iii) processes, (iv) determinations, or (v) analyses.

12. The non-transitory computer readable storage medium of claim 11, wherein the logic flow includes one or more predetermined rule sets.

13. The non-transitory computer readable storage medium of claim 9, wherein the business includes one of an individual, a group of individuals, an unincorporated association, a limited or general partnership, a corporation, or other business entity.

14. The non-transitory computer readable storage medium of claim 9, wherein the proposed communication message metadata includes an identifier of the business, an identifier of the intended recipient, the time of delivery and the communication type.

15. The non-transitory computer readable storage medium of claim 9 having stored thereon further instructions that, when executed by the one or more processors, perform operations further comprising:
responsive to determining transmission of the proposed communication message to the intended recipient at the specified time of delivery would violate the one or more regulations, transmitting a denial response to the business including a reason for violation.

16. The non-transitory computer readable storage medium of claim 9, further comprising:
responsive to determining transmission of the proposed communication message to the intended recipient at the specified time of delivery would not violate the one or more regulations, transmitting an approval response to the business, and storing (i) the request and (ii) a version of the selected workflow used in whether transmission of the proposed communication message to the intended recipient at the specified time of delivery would violate the one or more regulations.

17. A non-transitory computer readable storage medium having logic stored thereon, the logic being executable by one or more processors and including:
a management logic to receive, from a business, a request for a determination as to whether the business may transmit a proposed communication to an intended recipient at a specified time of delivery will violate legislation or rules specific to the business; and
a compliance logic to determine whether the proposed communication to the intended recipient for delivery at the specified time of delivery will violate the legislation or the rules specific to the business.

18. The non-transitory computer readable storage medium of claim 17, wherein the logic further comprises:
a subscription logic to track an opt-status of the intended recipient who is to receive communications from the business, wherein the opt-status is utilized by the compliance logic in determining whether the proposed communication to the intended recipient for delivery at the specified time of delivery will violate the legislation or the rules specific to the business.

19. The non-transitory computer readable storage medium of claim 17, wherein the compliance logic is configured to: (i) determine a workflow to be used in analyzing whether transmission of the proposed communication to the intended recipient for delivery at the specified time of delivery will violate the legislation or the rules specific to the business, (ii) retrieve metadata pertaining to at least one of the business or the intended recipient, (iii) retrieve the workflow from a compliance database, (iv) analyze the workflow according to the metadata and the request to determine whether transmission of the proposed communication to the intended recipient for delivery at the specified time of delivery would violate the legislation or the rules specific to the particular business, and wherein, the management logic is configured to transmit a notification to the business including results of analysis of the workflow by the compliance logic.

20. The non-transitory computer readable storage medium of claim 17, wherein the metadata includes one or more of: (i) a business identifier, (ii) the specified time of delivery of the proposed communication, (iii) a category of the proposed communication, (iv) a channel over which the proposed communication is to be transmitted, (v) an opt-status of the intended recipient, or (vi) a communication history between the business and the intended recipient.
